(19) United States
(12) Patent Application Publication
(10) Pub. No.: US 2016/0065019 A1
(43) Pub. Date: Mar. 3, 2016

(54) Subterranean Magnetic Turbine System

(71) Applicant: Michael Charles Bertsch, San Francisco, CA (US)

(72) Inventor: Michael Charles Bertsch, San Francisco, CA (US)

(21) Appl. No.: 14/934,095

(22) Filed: Nov. 5, 2015

Related U.S. Application Data
(63) Continuation-in-part of application No. 14/189,936, filed on Feb. 25, 2014, now abandoned.
Application No. 14/189,936 is a continuation-in-part of application No. 13/269,105, filed on Oct. 7, 2011, now abandoned.
(60) Provisional application No. 61/404,655, filed on Oct. 7, 2010.

(51) Int. Cl. H02K 1/27; H02K 1/17; H02J 7/14; H02K 7/00; H02K 7/102; H02K 7/116; H02K 11/00; H02K 5/04

(52) U.S. Cl. CPC H02K 1/2786; H02K 11/0094; H02K 1/17; H02K 11/0073; H02K 11/0005; H02K 5/04; H02K 7/003; H02K 7/102; H02K 7/116; H02J 7/14

(57) ABSTRACT

A permanent magnet electric apparatus has a rotor structure where a rotor has an outer rim, a plurality of rotor magnets, wherein each of the rotor magnets are recessed within a housing, where each housing is attached to the outer rim of the rotor structure and evenly spaced along the outer rim. The apparatus also has an output shaft, a plurality of gears connected between the rotor and the output shaft and configured to direct movement from the rotor to rotation of the output shaft, a stator structure adjacent to the rotor with at least one stator magnet configured to repel the plurality of rotor magnets where the magnetic force of the rotor magnets in a repelling position are configured to oppose the magnetic force of the at least one stator magnet as the rotor turns. A brake mechanism is configured to stop the rotation of the rotor structure.

### CROSS-REFERENCE TO RELATED APPLICATION

The present application is a continuation-in-part of, and claims priority to, U.S. Nonprovisional patent application Ser. No. 14/189,936 filed on Feb. 25, 2014, entitled “SMT System” which is a continuation-in-part of U.S. Nonprovisional patent application Ser. No. 13/269,105, which claims benefit of U.S. Provisional Patent Application 61/374,679 filed on Aug. 18, 2010, the entire disclosures of which are incorporated by reference herein.

### BACKGROUND OF THE INVENTION

1. Field of Invention

This invention relates to energy conversion devices, more particularly electrical generators.

2. Description of Related Art

Electrical generators and/or turbine are devices that convert mechanical energy into electrical energy and are well known. The underlying operating principal of these generators can be found in Faraday's law, which, in its most basic form, states that an electrical potential difference is generated between the ends of an electrical conductor that moves perpendicularly through a magnetic field. More specifically, that the electromotive force (EMF) that is induced in any closed circuit is equal to the time rate of change of the magnetic flux through the circuit.

An electrical generator in its most simple form comprises a rotor and a stator. The rotor is a rotating part of the generator and the stator is a stationary part. One particular class of electrical generator makes use of permanent magnets (PMs), mounted on either the rotor or the stator, to establish a magnetic field (flux) in the generator. These generators are referred to as permanent magnet generators. Coils of conductive material, generally copper wire, are secured to either the stator or the rotor of the generator and as the rotor rotates with respect to the stator, the movement of the magnetic field relative to the conductive windings induces a current in the windings. The current, so induced, may then be used to power electrical appliances or to store electrical charge by, for example, charging batteries.

Electrical generators are currently used in a number of applications, but are becoming increasingly popular for use in wind generators, mainly because electricity generated by means of wind is considered to be a clean source of energy. Wind generators convert the kinetic energy of wind into mechanical (mostly rotational) energy, which is then converted into useful electrical energy. A basic wind generator includes a number of aero foil shaped blades, mounted on an axle for rotation in wind. The rotation is imparted to the rotor of an electrical generator, which then generates electricity. Conventional wind generators suffer from a number of disadvantages. One such disadvantage is that the majority of such generators utilize iron core stators. Apart from the high cost associated with iron cores, they are also heavy and require additional resources and support to install, stabilize and maintain. Iron core stators also suffer from cogging torque, which is the torque resulting from the interaction between the permanent magnets of the rotor and the stator slots of a PM machine. It is also known as detent or “no-current” torque. Cogging torque is an undesirable component for the operation of iron-core electric generators. It is especially prominent at lower speeds and manifests itself in stuttered rotation. A further disadvantage of conventional wind generators is the cost associated with their repair and maintenance. In particular, where windings on either the rotor or stator become worn or defective, highly skilled technicians are required to conduct repair or maintenance. The weight and unwieldiness of conventional iron-core stators also often require the use of machinery or teams of technicians to conduct even routine maintenance.

One improved type of wind generator that has been used with some success, particularly in wind generators, is known as a double-sided rotor, air-cored permanent magnet generator. Due to its air core stator, the generator does not suffer from some of the disadvantages mentioned above resulting from a heavy iron core generator. These generators have numerous advantages such as no core losses, zero cogging torque, no attractive forces between the stator and rotor and the ability of replacing faulty stators in situ. The stators are, however, still difficult to repair and maintain, and still require highly skilled technicians and expensive equipment to do so. In addition, these machines suffer from large attractive forces between the two PM rotors and normally require a relatively large number of PM magnets to operate due to the fact that they have a relatively larger air gap between the rotors and stator.

Therefore, there is a need for a device that can convert mechanical energy into clean, efficient, and cost effective electrical power. The present invention overcomes the deficiencies of such design for a permanent magnet electric apparatus.

### SUMMARY OF THE INVENTION

The foregoing, and other features and advantages of the invention, will be apparent from the following, more particular description of the preferred embodiments of the invention, the accompanying drawings, and the claims.

A permanent magnet electric apparatus has a rotor structure where a rotor has an outer rim, a plurality of rotor magnets, wherein each of the rotor magnets are recessed within a housing, where each housing is attached to the outer rim of the rotor structure and evenly spaced along the outer rim. The apparatus also has an output shaft, a plurality of gears connected between the rotor and the output shaft and configured to direct movement from the rotor to rotation of the output shaft, a stator structure adjacent to the rotor with at least one stator magnet configured to repel the plurality of rotor magnets where the magnetic force of the plurality of rotor magnets in a repelling position are configured to oppose the magnetic force of the at least one stator magnet as the rotor turns. A brake mechanism is mechanically engaged with the rotor structure and configured to stop the rotation of the rotor structure.

In an embodiment, the permanent magnet electric apparatus has a control panel with a switch. The switch is configured to control a circuit. The circuit includes a battery, an alternator; and a voltage regulator. The alternator and the voltage regulator are also in communication with the control panel.

In an alternative embodiment, the battery of the permanent magnet electric apparatus is rechargeable.

In an embodiment, the housing of the rotor magnets of the permanent magnet electric apparatus is made of a magnetic shielding material. The magnetic shielding material is capable of redirecting the magnetic forces and flux of the rotor magnets and the magnetic forces and flux of the one more stator magnets.

In another embodiment, the stator of the permanent magnet electric apparatus is made of a magnetic shielding material configured to redirect the magnetic forces of the plurality of rotor magnets and the magnetic forces of the one more stator magnets.

In another embodiment, the permanent magnet electric apparatus has one or more voltage regulators and an alternator. The alternator is can convert rotational energy to electricity. The voltage regulator is regulates ingress and egress of electrical current flow from the battery.

In an embodiment, the stator structure is recessed.

In an alternative embodiment, the stator magnets are conically arranged within the stator.

In an embodiment, the rechargeable battery cell has an assembly with one or more charging circuits connected to a charger. The charger is configured to store energy in the battery, and a controller connected to the charger to for charging the rechargeable battery.

In an embodiment, the brake is hydraulic, and the battery is in communication with a hydraulic brake gear motor. The hydraulic brake gear motor is configured to operate the hydraulic brake.

In an embodiment, the permanent magnet electric apparatus has a rotor structure with a rotor that has an outer rim, and a plurality of rotor magnets recessed within a housing. Each housing is attached to the outer rim of the rotor structure and evenly spaced along the outer rim. The apparatus also has an output shaft and a plurality of gears, connected between the rotor and the output shaft, configured to direct movement from the rotor to rotation of the output shaft. The apparatus also has a stator structure adjacent to the rotor. The stator structure has at least one stator magnet configured to repel the rotor magnets. A brake mechanism mechanically is engaged with the rotor structure configured to stop the rotation of the rotor structure. The apparatus also has a battery, and a motor engaged with the rotor structure. The motor is configured to start the rotation of the rotor and disengage from the rotor structure after rotation of the rotor is initiated, The motor is connected in a circuit with the battery. The magnetic force of the plurality of rotor magnets in a repelling position are configured to oppose the magnetic force of the plurality of stator magnets.

In an embodiment, the apparatus has a control panel having an ON/OFF switch configured to control a circuit. The switch can START/STOP the system through control of he circuit with the battery and motor. A battery is in circuit with the switch. An alternator and a voltage regulator are connected through a circuit with the control panel.

In an alternative embodiment, the battery of the permanent magnet electric apparatus is rechargeable.

### BRIEF DESCRIPTION OF THE DRAWINGS

FIG. 1 depicts a front-cutaway view drawing illustrating an exemplary of the Subterranean Magnetic Turbine (SMT) System according to the present invention;

FIG. 2 depicts a side-cutaway view drawing illustrating an exemplary of the SMT System according to the present invention;

FIG. 3 depicts a top-cutaway view drawing illustrating an exemplary of the SMT System according to the present invention;

### DETAILED DESCRIPTION OF PREFERRED EMBODIMENTS

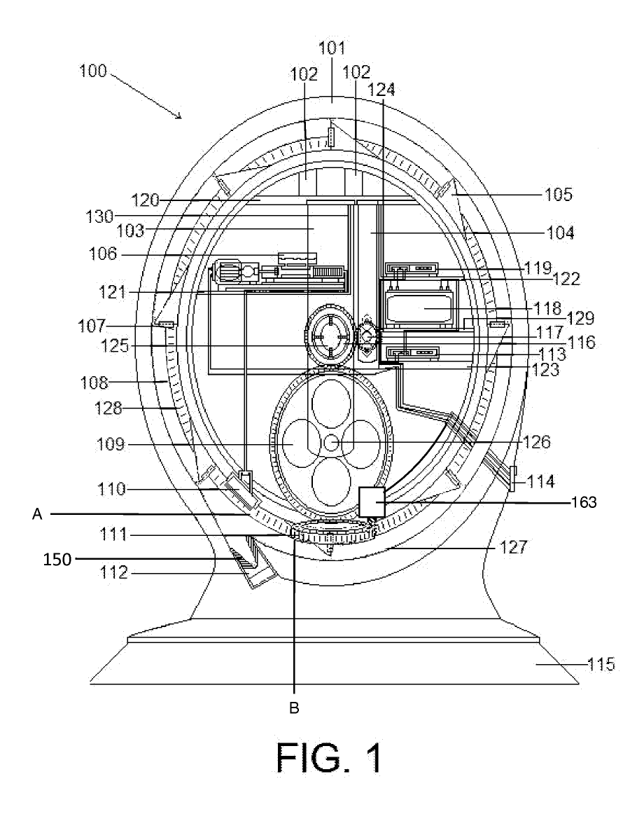

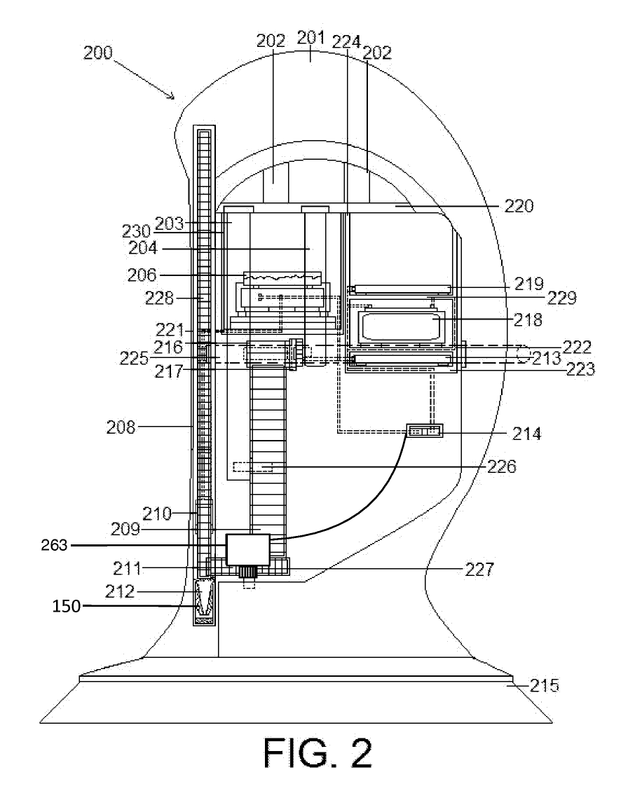

Preferred embodiments of the present invention and their advantages may be understood by referring to FIGS. 1-2 wherein like reference numerals refer to like elements.

The present invention provides a permanent magnet driven electric apparatus, which is designed to couple to such a generator and/or turbine output shaft to generate electricity through a conversion a mechanical energy. More particularly, the invention seeks to provide a permanent magnet electric apparatus including a rotor structure and a stator structure. A magnet assembly fastened to such outer rim of such rotor includes a plurality of such equally spaced recessed magnets that act against each other and in such keep attracting and/or repelling when passing in such rotation a recessed stator structure at base of such structure. The recessed stator structure has a plurality of such angled and/or wedged magnets housed in such a cone shaped structure and are in such oriented opposing to such (NS) thus creating repelling forces needed for such rotation. The permanent magnet electric apparatus includes a rigid spherically shaped supporting outer structure and/or irregular shaped structure and/or enclosure that houses in such a permanent magnet electric apparatus which includes a plurality of gears, a rechargeable battery including assembly, hydraulic breaking system including assembly and an electric starting mechanism including assembly. The following detailed description includes references to the accompanying drawings, which form a part of the detailed description. The drawings show, by way of illustration, specific embodiments in which the invention may be practiced. These embodiments are sufficiently described to enable one skilled in the art to practice the invention. The embodiments may be combined, other embodiments may be utilized, or structural, and logical changes may be made without departing from the scope of the present invention. The following detailed description is, therefore, not to be taken in a limiting sense, and the scope of the present invention is defined by the appended claims and their equivalents. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the claims made herein. The referenced items are provided solely for their disclosure prior to the filing date of the present application. Nothing herein is to be construed as an admission that the present invention is not entitled to antedate such material by virtue of prior invention. Unless otherwise indicated, the words and phrases presented in this document have their ordinary meanings to one of skill in the art. Such ordinary meanings can be obtained by reference to their use in the art and by reference to general and scientific dictionaries, for example, Webster's Third New International Dictionary, Merriam-Webster Inc., Springfield, Mass., 1993 and The American Heritage Dictionary of the English Language, Houghton Mifflin, Boston Mass., 1981. References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. The following explanations of certain terms are meant to be illustrative rather than exhaustive. These terms have their ordinary meanings given by usage in the art and in addition include the following explanations. As used herein, the term “and/or” refers to any one of the items, any combination of the items, or all of the items with which this term is associated. As used herein, the singular forms “a,” “an,” and “the” include plural reference unless the context clearly dictates otherwise. It is further noted that the claims may be drafted to exclude any optional element. As such, this statement is intended to serve as antecedent basis for use of such exclusive terminology as “solely,” “only,” and the like in connection with the recitation of claim elements, or use of a “negative” limitation. As used herein, the term “coupled” means the joining of two members directly or indirectly to one another. Such joining may be stationary in nature or movable in nature and/or such joining may allow for the flow of fluids, electricity, electrical signals, or other types of signals or communication between two members. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature. As used herein, the terms “include,” “for example,” “such as,” and the like are used illustratively and are not intended to limit the present invention. As used herein, the terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention. As used herein, the terms “front,” “back,” “rear,” “upper,” “lower,” “right,” and “left” in this description are merely used to identify the various elements as they are oriented in the FIGS, with “front,” “back,” and “rear” being relative apparatus. These terms are not meant to limit the element that they describe, as the various elements may be oriented differently in various applications. It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

One skilled in the art would appreciate that the invention follows the principles of physics and conservation of energy, and may be described mathematically by the following equation:

Mathematical Glossary of Variables/Constants for (the SMT System)

c=conversion factor from kinetic energy of wheel to energy output of system
E=total energy output of system
f=friction/resistive forces against magnet wheel rotation
Fb=magnetic force of magnetic beam
Ff=magnetic force of magnets of wheel
F total=total magnetic force
I=moment of inertia about center of magnet wheel rotation, also the center of the wheel
k=kinetic energy of magnet wheel
w=terminal angular velocity of magnet wheel

Equations Working Backwards from Total Energy Output of System

E=ck

k=½*Iw²

The kinetic energy is based on the terminal angular velocity of the wheel, achieved when the force of the friction of the system equals that of the magnetic forces.

Energy lost in the form of heat to the environment as friction f slowly diminishes the total energy of the system. So terminal velocity is achieved when fw=Ftotal. Solving for w:

w=Ftotal/f

Ftotal=Fb+Ff

With reference to FIG. 1, a front cutaway view is shown illustrating a SMT System 100 according to an embodiment of the present invention; The permanent magnet electric apparatus 100 includes a rigid spherically shaped supporting outer structure and/or irregular shaped structure and/or enclosure 101 that houses in such a permanent magnet electric apparatus 100. In this embodiment one or more parallel spaced apart support columns 102 which include a support assembly (not shown) are fastened by means to such upper floor support beam 120 and such upper interior wall (not shown) of such rigid spherically shaped supporting structure and/or irregular shaped structure and/or enclosure 101. A middle support column 103 is fastened by means to such upper floor support beam 120 and in such supports the first rotatable gear 109 including assembly 126 (partially shown). A second rotatable gear 111 including assembly 127 (partially shown) is included and is in constant mesh with such first gear 109 and such third gear and/or rotatable rotor structure 128 which includes such assembly (not shown). The third rotatable gear and/or rotatable rotor structure 128 including assembly (not shown) is in constant rotation from such repelling forces from a plurality of rotor magnets 107. Each rotor magnet 107 within the rotor structure 128 are equally spaced and recessed into a housing 105.

In an embodiment, the housing 105 is comprised of a material magnetic shielding material. These materials are well known in the art for their capability of conducting the magnetic flux due to a higher magnetic permeability. Any ferromagnetic material has magnetic shielding properties. The specific material used corresponds with the size and type of magnets in the stator and rotor. For example, super conductors or conductive materials such as copper or steel are known to be able to conduct the magnetic field.

In an alternative embodiment, the stator 112 and the housing 105 are a magnetic shielding materials such as steel.

In an embodiment, each rotor magnet 107 acts against each other and in such keep attracting and/or repelling when passing in such rotation a recessed stator structure 112 at base of such structure. The recessed stator structure 112 has a plurality of such angled and/or wedged stator magnets 150 housed in such a cone shaped structure and are in such oriented apposing to such North-South (NS) poles thus creating repelling forces needed for such rotation which includes a chamber for housing 108 such third gear and/or rotatable rotor structure 128. The permanent magnet electric apparatus 100 includes a hydraulic brake gear motor with a brake mechanism assembly 110 (partially shown) with one or more such chambers for such storage of hydraulic fluid 106.

In an alternative embodiment, the brake mechanism assembly 110 is a mechanical brake.

In the embodiment shown in FIG. 1, a control panel 114 fastened by means to such exterior of such rigid spherically shaped supporting structure and/or irregular shaped structure and/or enclosure 101 of such permanent magnet electric apparatus 100. The control panel 114 includes an ON/OFF switch and/or button for switching the power supply and/or the releasing and/or stopping of such hydraulic brake gear motor with a brake mechanism assembly 110 (partially shown).

In an embodiment, the permanent magnet electric apparatus 100 has a motor 163 in communication with a rechargeable battery 118 and the control panel 114, having an ON/OFF switch. The ON/OFF switch is electrically engaged with the motor 163.

In an embodiment, the motor 163 is configured to engage the rotor structure 128 wherein the motor will directly engage the rotor to translate rotational forces to start the system.

In an embodiment, the motor 163 has a solenoid (not shown) configured extend the gear of the motor such that it engages with the rotor structure 128. When the motor 163 is engaged with the rotor structure 128, and the battery powers the motor 163, the motor 163 will translate rotational energy to the rotor structure 128 until the system is initiated. The system is initiated when the rotor structure is rotated and the rotor magnets has passed the stator at repelling point A, in a clockwise rotation.

In an alternative embodiment, the motor 163 is configured to engage the output shaft 125 wherein the motor 163 translates rotational energy from the motor 263 to the output shaft 125 and thereby to the rotor structure 128.

In an embodiment, the present invention includes a support base 115 for supporting a rigid spherically shaped supporting outer structure and/or irregular shaped structure and/or enclosure 101 that houses in such a permanent magnet electric apparatus 100. A fourth rotatable gear 116 is fastened by means to such output shaft 125 of such generator and/or turbine and is in such constant mesh with such first rotatable gear 109 and such fifth rotatable gear and/or alternator device 117. A support column 104 is fastened by means to such upper floor support beam 120 and in such supports such fifth rotatable gear and/or alternator device 117 including assembly (not shown). The fifth rotatable gear and/or alternator device 117 provided is in such connected to a voltage regulator device 113. The voltage regulator device 113 provided controls such fifth rotatable gear and/or alternator device 117 one or more outputs. A battery charging system is provided, comprising a rechargeable battery type device 118 which includes at least one rechargeable battery cell with such assembly (not shown) including one or more charging circuits connected to such charger connector, and a controller connected to such charger connector for the charging of such rechargeable type device 118 which includes a plurality of outputs. A voltage and/or current regulator 119 for regulating such electrical current flow entering and/or leaving such rechargeable battery type device 118 is included. The present invention includes one or more flooring systems 121,122,123,129 including supporting walls 124,130 that are fastened by means to a support (not shown) and are in such especially designed for the housing of such equipment, such as rechargeable battery type device 118, voltage regulator device 113, hydraulic brake gear motor with a brake mechanism assembly 110, voltage and/or current regulator 119.

With reference to FIG. 2, a side-cutaway view illustrating the SMT System 200 according to an embodiment of the present invention; The SMT System 200 includes a rigid spherically shaped supporting outer structure and/or irregular shaped structure and/or enclosure 201 housed within such a permanent magnet electric apparatus 200. In this embodiment one or more parallel spaced apart support columns 202 which include a support assembly (not shown) are fastened by means to such upper floor support beam 220 and such upper interior wall (not shown) of such rigid spherically shaped supporting structure and/or irregular shaped structure and/or enclosure 201. A middle support column 203 is fastened by means to such upper floor support beam 220 and in such supports the first rotatable gear 209 including assembly 226 (partially shown). A second rotatable gear 211 including assembly 227 (partially shown) is included and is in constant mesh with such first gear 209 and such third gear and/or rotatable rotor structure 228 which includes such assembly (not shown). The third rotatable gear and/or rotatable rotor structure 228 including assembly (not shown) is in constant rotation from such repelling forces from such magnet assembly (not shown). The magnet assembly is in such fastened by means to such outer rim (not shown) of such third gear and/or rotatable rotor structure 228 and includes a plurality of such equally spaced recessed magnets that act against each other and in such keep attracting and/or repelling when passing in such rotation a recessed stator structure 212 at base of such structure. The recessed stator structure 212 has a plurality of such angled and/or wedged magnets housed in such a cone shaped structure and are in such oriented apposing to such (NS) thus creating repelling forces needed for such rotation which includes a chamber for housing 208 such third gear and/or rotatable rotor structure 228. The permanent magnet electric apparatus 200 includes a hydraulic brake gear motor with a brake mechanism assembly 210 (partially shown) with one or more such chambers for such storage of hydraulic fluid 206. In the embodiment shown, a control panel 214 fastened by means to such exterior of such rigid spherically shaped supporting structure and/or irregular shaped structure and/or enclosure 201 of such permanent magnet electric apparatus 200. The control panel 214 includes an ON/OFF switch and/or button for switching the power supply and/or the releasing and/or stopping of such hydraulic brake gear motor with a brake mechanism assembly 210 (partially shown). The present invention includes a support base 215 for supporting a rigid spherically shaped supporting outer structure and/or irregular shaped structure and/or enclosure 201 that houses in such a permanent magnet electric apparatus 200. A fourth rotatable gear 216 is fastened by means to such output shaft 225 of such generator and/or turbine and is in such constant mesh with such first rotatable gear 209 and such fifth rotatable gear and/or alternator device 217. A support column 204 is fastened by means to such upper floor support beam 220 and in such supports such fifth rotatable gear and/or alternator device 217 including assembly (not shown). The fifth rotatable gear and/or alternator device 217 provided is in such connected to a voltage regulator device 213. The voltage regulator device 213 provided controls such fifth rotatable gear and/or alternator device 217 one or more outputs. A battery charging system is provided, comprising a rechargeable battery type device 218 which includes at least one rechargeable battery cell with such assembly (not shown) including one or more charging circuits connected to such charger connector; and a controller connected to such charger connector for the charging of such rechargeable battery type device 218 which includes a plurality of outputs. A voltage and/or current regulator 219 for regulating such electrical current flow entering and/or leaving such rechargeable battery type device 218 is included. The present invention includes one or more flooring systems 221,222,223,229 including supporting walls 224,230 that are fastened by means to a support (not shown) and are in such especially designed for the housing of such equipment, such as rechargeable battery type device 218, voltage regulator device 213, hydraulic brake gear motor with a brake mechanism assembly 210, voltage and/or current regulator 219.

FIG. 2 further illustrates an embodiment wherein the permanent magnet electric apparatus 200 has an electric motor 263 mounted to the structure. The motor 263 is in communication with the control panel 214 having an ON/OFF switch.

In an embodiment, the motor 263 is configured to engage the rotor structure 228 wherein the motor will directly engage the rotor to translate rotational forces to start the system.

In an alternative embodiment, the motor 263 is configured to engage the output shaft 225 wherein the motor 263 translates rotational energy from the motor 263 to the output shaft 225 and thereby to the rotor structure 228.

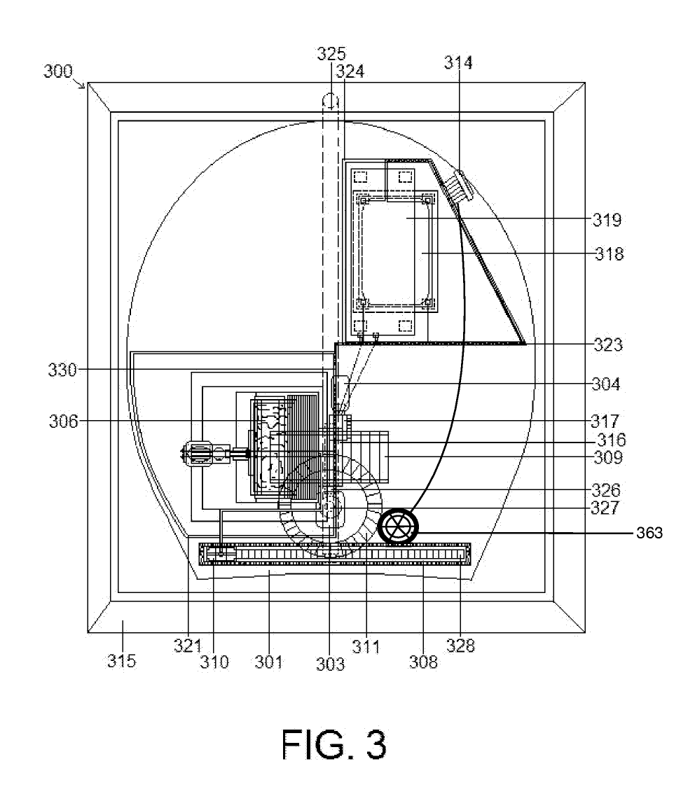

With reference to FIG. 3 a top-cutaway view drawing is shown, illustrating an embodiment of the SMT System according to the present invention; 300. The permanent magnet electric apparatus 300 includes a rigid spherically shaped supporting outer structure and/or irregular shaped structure and/or enclosure 301 that houses in such a permanent magnet electric apparatus 300. In this embodiment a middle support column 303 is fastened by means to such upper floor support beam (not shown) and in such supports the first rotatable gear 309 including assembly 326 (partially shown). A second rotatable gear 311 including assembly 327 (partially shown) is included and is in constant mesh with such first gear 309 and such third gear and/or rotatable rotor structure 328 which includes such assembly (not shown). The present invention includes a chamber for housing 308 such third gear and/or rotatable rotor structure 328. The third rotatable gear and/or rotatable rotor structure 328 including assembly (not shown) is in constant rotation from such repelling forces from such magnet assembly (not shown). The permanent magnet electric apparatus 300 includes a hydraulic brake gear motor with a brake mechanism assembly 310 (partially shown) with one or more such chambers for such storage of hydraulic fluid 306. In the embodiment shown, a control panel 314 fastened by means to such exterior of such rigid spherically shaped supporting structure and/or irregular shaped structure and/or enclosure 301 of such permanent magnet electric apparatus 300. The control panel 314 includes an ON/OFF switch and/or button for switching the power supply and/or the releasing and/or stopping of such hydraulic brake gear motor with a brake mechanism assembly 310 (partially shown). The present invention includes a support base 315 for supporting a rigid spherically shaped supporting outer structure and/or irregular shaped structure and/or enclosure 301 that houses in such a permanent magnet electric apparatus 300. A fourth rotatable gear 316 is fastened by means to such output shaft 325 of such generator and/or turbine and is in such constant mesh with such first rotatable gear 309 and such fifth rotatable gear and/or alternator device 317. A support column 304 is fastened by means to such upper floor support beam (not shown) and in such supports such fifth rotatable gear and/or alternator device 317 including assembly (not shown). The fifth rotatable gear and/or alternator device 317 provided is in such connected to a voltage regulator device (not shown). A charging system is provided, comprising a rechargeable battery type device 318 which includes at least one rechargeable battery cell with such assembly (not shown) including one or more charging circuits connected to such charger connector; and a controller connected to such charger connector for the charging of such rechargeable battery type device 318 which includes a plurality of outputs. A voltage and/or current regulator 319 for regulating such electrical current flow entering and/or leaving such rechargeable battery type device 318 is included. The present invention includes one or more flooring systems 321, 323 including supporting walls 324,330 that are fastened by means to a support (not shown) and are in such especially designed for the housing of such equipment, such as rechargeable battery type device 318, voltage regulator device (not shown), hydraulic brake gear motor with a brake mechanism assembly 310, voltage and/or current regulator 319.

In an embodiment, the motor 163 provides a starting mechanism to initiate the rotor structure 128. A user engages the ON/OFF switch of the control panel 114. When the switch is toggled into the ON position, the switch will close an electrical circuit comprising the rechargeable battery 118, and the motor 163. Upon receiving the current provided by the battery 118, the motor 163, will engage the rotor structure 128. The motor 163 will translate the rotational energy it provides to the rotor structure 128. The rotor structure 128 will begin to spin until the opposing forces between the plurality of magnets 107 and stator magnets 150, are sufficient to continue the rotation of the permanent magnet electric apparatus 100, without the continued assistance of the motor 163. The current to the motor 163 will then be discontinued as regulated by the control panel 114. The rotor structure 128, will continue to rotate due to the opposing magnetic forces between the rotor magnets 107 and the stator magnets 150, until the OFF position is selected by the user. When the user selects the off position, the hydraulic brake assembly 110 is initiated whereby the hydraulic brake assembly 110 will engage the rotor structure 128. The forces of the hydraulic brake assembly 128 will continue to act on the rotor structure 128 until the frictional forces overcome the magnetic interaction between the rotor structure 128 and the stator 112, ultimately stopping the permanent magnet electric apparatus 100.

In an alternative embodiment, the permanent magnet electric apparatus 100 has a plurality of rotor magnets 107 partially housed within magnetic shielding material. The housing 105 configured such that the plurality of rotor magnets 107 are only exposed on a single side such that the plurality of rotor magnets 107 will only interact with the stator magnets 150 when they have passed the position of stator 112.

In an embodiment, the mathematics defining the interaction of forces would be understood by one skilled in the art such that the opposing forces between the stator magnets 150 and the plurality of rotor magnets 107 on the rotor structure 128, in the repelling position A are greater than the forces in the opposite direction between the stator magnets 150 and the plurality of rotor magnets 107 in the pre-repelling position B. The opposing forces between the rotor magnets 107 and the stator magnets 150 past the repelling position A provide the driving force for the mechanical rotation of the permanent magnet electric apparatus 100.

Similarly, except as explicitly required by claim language, a single substance or component may meet more than a single functional requirement, provided that the single substance fulfills the more than one functional requirement as specified by claim language. All patents, patent applications, publications, scientific articles, web sites, and other documents and materials referenced or mentioned herein are indicative of the levels of skill of those skilled in the art to which the invention pertains, and each such referenced document and material is hereby incorporated by reference to the same extent as if it had been incorporated by reference in its entirety individually or set forth herein in its entirety. Additionally, all claims in this application, and all priority applications, including but not limited to original claims, are hereby incorporated in their entirety into, and form a part of, the written description of the invention. Applicant reserves the right to physically incorporate into this specification any and all materials and information from any such patents, applications, publications, scientific articles, web sites, electronically available information, and other referenced materials or documents. Applicant reserves the right to physically incorporate into any part of this document, including any part of the written description, the claims referred to above including but not limited to any original claims.

All patents, patent applications, publications, scientific articles, web sites, and other documents and materials referenced or mentioned herein are indicative of the levels of skill of those skilled in the art to which the invention pertains, and each such referenced document and material is hereby incorporated by reference to the same extent as if it had been incorporated by reference in its entirety individually or set forth herein in its entirety. Additionally, all claims in this application, and all priority applications, including but not limited to original claims, are hereby incorporated in their entirety into, and form a part of, the written description of the invention. Applicant reserves the right to physically incorporate into this specification any and all materials and information from any such patents, applications, publications, scientific articles, web sites, electronically available information, and other referenced materials or documents. Applicant reserves the right to physically incorporate into any part of this document, including any part of the written description, the claims referred to above including but not limited to any original claims.

I claim:

1. A permanent magnet electric apparatus, comprising:
a. a rotor structure comprising:
i. a rotor having an outer rim;
ii. a plurality of rotor magnets, wherein each of the plurality of rotor magnets are recessed within a housing, and wherein each housing is attached to the outer rim of the rotor structure and evenly spaced along the outer rim;
iii. an output shaft; and
iv. a plurality of gears connected between the rotor and the output shaft and configured to direct movement from the rotor to rotation of the output shaft;
b. a stator structure adjacent to the rotor, wherein the stator structure has at least one stator magnet, wherein the at least one stator magnet is configured to repel the plurality of rotor magnets;
c. a brake mechanism mechanically engaged with the rotor structure configured to stop the rotation of the rotor structure;
wherein the magnetic force of the plurality of rotor magnets in a repelling position are configured to oppose the magnetic force of the at least one stator magnet as the rotor turns.

2. The permanent magnet electric apparatus of claim 1, further comprising
a. a control panel having a switch, wherein the switch is configured to engage a circuit,
b. a battery wherein the battery is in electrically engaged with the switch; and
c. an alternator, and
d. a voltage regulator,
wherein the alternator and the voltage regulator are in electrically engaged with the control panel.

3. The permanent magnet electric apparatus of claim 1, wherein the battery is rechargeable.

4. The permanent magnet electric apparatus of claim 1, wherein the housing comprises a magnetic shielding material configured to redirect the magnetic forces of the plurality of rotor magnets and the magnetic forces of the one more stator magnets.

5. The permanent magnet electric apparatus of claim 1, wherein the stator comprises a magnetic shielding material configured to redirect the magnetic forces of the plurality of rotor magnets and the magnetic forces of the one more stator magnets.

6. The permanent magnet electric apparatus of claim 1, further comprising:
a. one or more voltage regulators; and
b. an alternator wherein the alternator is configured to convert rotational energy to electricity,
wherein the one or more voltage regulators is configured to regulate ingress and egress of electrical current flow from the battery.

7. The permanent magnet electric apparatus of claim 1, wherein the one or more stator magnets are conically arranged within the stator.

8. The permanent magnet electric apparatus of claim 1, wherein the stator structure is recessed.

9. The permanent magnet electric apparatus of claim 3, wherein the at least one rechargeable battery cell comprises:
a. an assembly having one or more charging circuits connected to a charger, wherein the charger is configured to store energy in the battery; and
b. a controller connected to the charger for the charging of the rechargeable battery.

10. The permanent magnet electric apparatus of claim 2, wherein the brake is hydraulic, wherein battery is in communication with a hydraulic brake gear motor, and wherein the hydraulic brake gear motor is configured to operate the hydraulic brake.

11. A permanent magnet electric apparatus, comprising:
d. a rotor structure comprising:
i. a rotor having an outer rim;
ii. a plurality of rotor magnets, wherein each of the plurality of rotor magnets are recessed within a housing, and wherein each housing is attached to the outer rim of the rotor structure and evenly spaced along the outer rim;
iii. an output shaft; and
iv. a plurality of gears connected between the rotor and the output shaft and configured to direct movement from the rotor to rotation of the output shaft;
e. a stator structure adjacent to the rotor, wherein the stator structure has at least one stator magnet, wherein the at least one stator magnet is configured to repel the plurality of rotor magnets;
f. a brake mechanism mechanically engaged with the rotor structure configured to stop the rotation of the rotor structure;
g. a battery;
h. a motor, wherein the motor is engaged with the rotor structure, wherein the motor is configured start the rotation of the rotor, wherein the motor is configured to disengage from the rotor structure after rotation of the rotor is initiated, and wherein the motor is in electrical communication with the battery,
wherein the magnetic force of the plurality of rotor magnets in a repelling position are configured to oppose the magnetic force of the plurality of stator magnets.

12. The permanent magnet electric apparatus of claim 11, further comprising
a. a control panel having a switch, wherein the switch is configured to engage a circuit,
b. a battery wherein the battery is in electrically engaged with the switch; and
c. an alternator, and
d. a voltage regulator,
wherein the alternator and the voltage regulator are in electrically engaged with the control panel. The permanent magnet electric apparatus of claim 1, wherein the battery is rechargeable.

13. The permanent magnet electric apparatus of claim 11, wherein the housing comprises a magnetic shielding material.

14. The permanent magnet electric apparatus of claim 11, wherein the stator comprises a magnetic shielding material.

15. The permanent magnet electric apparatus of claim 11, further comprising:
a. one or more voltage regulators; and
b. an alternator wherein the alternator is configured to convert rotational energy to electricity,
wherein the one or more voltage regulators is configured to regulate ingress and egress of electrical current flow from the battery.

16. The permanent magnet electric apparatus of claim 11, wherein the one or more stator magnets are conically arranged within the stator.

17. The permanent magnet electric apparatus of claim 11, wherein the stator structure is recessed.

18. The permanent magnet electric apparatus of claim 12, wherein the at least one rechargeable battery cell comprises:
a. an assembly having one or more charging circuits connected to a charger, wherein the charger is configured to store energy in the battery; and
b. a controller connected to the charger for the charging of the rechargeable battery.

19. The permanent magnet electric apparatus of claim 2, wherein the brake is hydraulic, wherein battery is in communication with a hydraulic brake gear motor, and wherein the hydraulic brake gear motor is configured to operate the hydraulic brake.
